(19) United States
(12) Patent Application Publication
(10) Pub. No.: US 2017/0301079 A1
(43) Pub. Date: Oct. 19, 2017

(54) METHOD OF ACQUIRING TSOM IMAGE AND METHOD OF EXAMINING SEMICONDUCTOR DEVICE

(71) Applicant: INCHEON UNIVERSITY INDUSTRY ACADEMIC COOPERATION FOUNDATION, Incheon (KR)

(72) Inventors: Joong-Hwee Cho, Incheon (KR); Hee-Chul Choi, Incheon (KR); Jun-Hee Kang, Incheon (KR); Seung-II Shin, Incheon (KR); Hyeong-Bok Kim, Incheon (KR)

(73) Assignee: INCHEON UNIVERSITY INDUSTRY ACADEMIC COOPERATION FOUNDATION, Incheon (KR)

(21) Appl. No.: 15/391,502

(22) Filed: Dec. 27, 2016

(30) Foreign Application Priority Data
Apr. 19, 2016 (KR) 10-2016-0047402
Apr. 19, 2016 (KR) 10-2016-0047403
Dec. 12, 2016 (KR) 10-2016-0168385

(51) Int. Cl. G06T 7/00; G06T 7/97

(52) U.S. Cl. CPC G06T 7/0004; G06T 2207/30148; G06T 7/97; G06T 2207/10004

(57) ABSTRACT

Methods of acquiring a through-focus scanning optical microscopy (TSOM) image and inspecting a semiconductor device are provided. A method of acquiring the TSOM image includes: acquiring a plurality of actual images of different focal positions and out-of-focus degrees (distances) of the actual images with respect to an inspection object through an optical tool; acquiring a plurality of virtual images having different focal positions from the actual images and the focal positions thereof, based on the actual images and the out-of-focus degrees of the actual images; and acquiring a TSOM image of the inspection object by using the actual images and the virtual images. According to a method of acquiring the TSOM image and the method of inspecting the semiconductor device, it is possible to acquire high-precision TSOM images of the object with less effort and time and to inspect the semiconductor device efficiently and at low cost.

### CROSS-REFERENCE TO RELATED APPLICATIONS

This application claims the benefit of Korean Patent Application Nos. 10-2016-0047402, 10-2016-0047403, filed on Apr. 19, 2016, and 10-2016-0168385, filed on Dec. 12, 2016, in the Korean Intellectual Property Office, the disclosures of which are incorporated herein in their entirety by reference.

### BACKGROUND OF THE INVENTION

### 1. Field of the Invention

The present invention relates to a method of inspecting a semiconductor device, and more particularly, to a method of acquiring a through-focus scanning optical microscopy (TSOM) image for inspection of a semiconductor device and a method of inspecting a semiconductor device.

### 2. Description of the Related Art

Ravikiran Attota et. al. of the U.S. National Institute of Standards and Technology (NIST) suggested the possibility that three-dimensional (3D) fine patterns could be measured by using a TSOM.

This technology uses an existing optical microscope, but uses a method of collecting two-dimensional (2D) images of the same object at different focal positions and forming a 3D image data space for the object. Thus, the 2D images constitute a through-focus image that includes an in-focus image and a plurality of out-of-focus images. Computer processing is performed on such a 3D image data space. A computer extracts a brightness profile from a plurality of through-focus images collected for the same object and forms a TSOM image by using focal position information.

A TSOM image, which is constituted by using images provided by the TSOM, does not concretely represent an object as it is. Although slightly abstract, a difference between these images makes it possible to infer a minute shape difference of a measured 3D target structure.

It is known that the TSOM image can measure sub-10 nanometer features through simulation research, and the TSOM image suggests the possibility of fine 3D structure shape analysis.

Such a TSOM technology suggests a method that can inspect a semiconductor device with the degree of precision of an electron microscope by using optical equipment. However, the use of the TSOM technology is required to acquire a plurality of images with different focal depths. To this end, it is usually necessary to change a position of an inspection object or change the setting of optical equipment, such as a lens position of an inspection apparatus. Accordingly, the quick inspection of the semiconductor device at an inspection field may be delayed and field application may be difficult.

That is, in order to increase the accuracy of inspection through the TSOM image, it is necessary to secure images at more focal positions and acquire a TSOM image through the secured images. However, in this regard, it is necessary to change the setting, for example, a physical position of the inspection object or the optical equipment, and this is costly and time-consuming.

The TSOM technology does not use an actual image of an object, but uses patterns to determine a shape and a size of a specific portion of an actual semiconductor device or determines whether the semiconductor device is normal or abnormal. Even when a TSOM image of an inspection object is acquired, the shape, size, and normality or abnormality thereof cannot be immediately determined. A structure, shape, and size of a semiconductor device, to which a TSOM image of a certain pattern corresponds, can be known through an actual inspection using other methods such as SEM. By expanding this, when a TSOM image of an unknown object is acquired, a shape, size, and normality or abnormality of the object can be known by using the already obtained correspondence data.

For example, a TSOM image is acquired for a semiconductor device part whose at least one inspection object item (parameter) and related matters (values, numerical ranges) thereof are known, and a database is created in association with all items, matters, and images. If an unknown inspection object is present, a TSOM image thereof is acquired and the acquired TSOM image is compared with a TSOM image of each item and matter of the already created database. Then, an item and a matter corresponding to a TSOM image having the smallest image difference are determined as an item and a matter of the unknown inspection object.

For comparison of the two TSOM images, an MSD method may be used. That is, a difference value of brightness values or color values of each pixel of the TSOM image is obtained, the square of the difference value is added with respect to all pixels, and then, the resultant value is divided by the total number of pixels.

However, in a case where this method is used, each item and a TSOM image for each category of the item must be secured. To this end, a lot of TSOM images need to be secured. If images are required at a lot of focal positions for each object so as to secure each TSOM image, too many pre-processes must be performed so as to inspect the object by using the TSOM image.

Also, when an error occurs due to inaccurate registration of images, the accuracy of measurement is greatly reduced. As data of the database increases, it takes much time for inspection calculation.

Consequently, in securing a TSOM image of a certain object, if an accurate TSOM image can be acquired just by images at minimal different focal positions, it is very preferable because cost and time involved in acquiring the TSOM image can be reduced.

Therefore, inspection may be performed with high accuracy of an electronic microscope by using the potential and advantages of the TSOM technology and relatively inexpensive optical equipment. In spite of the advantages and potential that can apply to process inspection without stopping production processes or destructing objects, the TSOM technology is not being appropriately applied to an actual inspection of a semiconductor device. At the present time, in order to apply the TSOM technology to field inspection during a specific production process of a semiconductor device, there is a need to develop a specific inspection method that can quickly perform image acquisition and analysis required for application of the TSOM technology and can automate these processes.

On the other hand, deep learning refers to a technology used for classifying or grouping things or data. Deep learning is a type of machine learning that trains a computer to classify things just like a human brain distinguishes things.

The term “deep learning” was used for the first time in a paper of Geoffrey Hinton, a processor of University of Toronto, U.S.A., in 2006, and the basic concept of deep learning is similar to artificial neural network (ANN). The ANN is an algorithm that processes information in a manner similar to that of a human brain and learns information by repeating a process of combining and classifying data of various factors such as faces or shapes of things. Hinton suggested, in his paper, a method that can overcome drawbacks of an existing ANN model. With the advances in hardware capable of analyzing a large quantity of data and the advent of big data, the ANN has showed more excellent results. This is called “deep learning”.

One of features of deep learning is a data classification method through unsupervised learning. Generally, a data classification method of a computer is divided into supervised learning and unsupervised learning. Supervised learning is a method that inputs a classification criterion to a computer, and an existing machine learning algorithm usually classifies data through the supervised learning method. Unsupervised learning is a method that inputs information without specific classification criterion and causes a computer to automatically classify information. High computing capability is required for the computer to automatically find similar groups and classify data. Deep learning performs ANN optimization by processing data through pre-training using the unsupervised learning method.

For example, the computer finds a consistent pattern based on input data and forms a feature map. The computer may extract features from a small feature to a large feature. The performance of the algorithm depends greatly on how excellent feature is found. More difficult contents can be learnt at upper layers through a convolutional neutral network (CNN) algorithm that extracts features through multiple steps. Since the learning is performed at deeper levels through multiple steps, the term “deep learning” originated therefrom. If a pattern can be found from given data through a feature map and data can be classified just like a human distinguishes things, the computer can accurately distinguish a newly input photo based on a criterion. The characteristics of deep learning are that the processes from feature extraction to learning are included in the algorithm.

Such deep learning has recently achieved excellent results in speech recognition and image recognition fields. In the image recognition field, important contents are a feature map extraction using a basic model, in which an input calculates an output by a logic function and a weighted value, and a convolutional pooling concept, based on a biological neural network.

However, it was not until recently that deep learning attracted attention, in spite of its great potential, and the concept of deep learning itself has not been generalized. Thus, it is difficult to approach deep learning. For better understanding and application, it is necessary to understand related knowledge, such as cognition science or artificial intelligence, statistics or big data, knowledge about computer hardware and software through algorithms, and the like. Accordingly, deep learning is not sufficiently utilized in various fields.

### PRIOR ART DOCUMENTS

### Patent Documents

Patent Document 1: KR 10-1523336 B1

Patent Document 2: KR 10-1507950 B1

### Non-Patent Documents

Non-Patent Document 1: “TSOM method for semiconductor metrology”, Proc.SPIE 7971, Metrology, Inspection, and Process Control for Microlithography XXV, 79710T (Apr. 20, 2011)

### SUMMARY OF THE INVENTION

The present invention has been made in an effort to solve problems of a conventional method of inspecting a semiconductor device through TSOM images, and one or more embodiments of the present invention include a method of acquiring high-precision TSOM images of an object with less effort and time and a method of inspecting a semiconductor device through these TSOM images.

One or more embodiments of the present invention include a method of acquiring an image having a sufficient number of different focal depths to obtain an accurate TSOM image while not greatly or frequently changing optical setting or positions of the object in a direction of a focal distance, and a method of inspecting a semiconductor device by using the same.

One or more embodiments of the present invention include a novel method of inspecting a semiconductor device, which is capable of inspecting an inspection object more accurately and quickly by specifying an inspection tool through deep learning with respect to data.

One or more embodiments of the present invention include a method of acquiring a TSOM image, which has suitability to reduce time and effort for construction of a verification dataset or a database that may be important matters when a method of inspecting a semiconductor device is initially executed.

One or more embodiments of the present invention include a method of inspecting a semiconductor device, which can be used to inspect the semiconductor device more practically and more efficiently by overcoming limitations in using TSOM images.

More specifically, one or more embodiments of the present invention include a practical method capable of inspecting a semiconductor device efficiently and at low costs while providing advantages of TSOM by combining a deep learning technology with the inspection of the semiconductor device using TSOM.

One or more embodiments of the present invention include a method of inspecting a semiconductor device, which can be applied to a practical process inspection of a semiconductor device, based on the fact that an image recognition field is regarded as one of fields where a deep learning technology approaches most realistically and achieves excellent results and a probability that deep learning has suitability for, in particular, recognition and analysis of TSOM images close to an abstract pattern, not an actual shape of an object.

One or more embodiments of the present invention include a method of inspecting a semiconductor device, which is capable of minimizing an inspection error by representing an inspection object image in a probability distribution form with respect to all categories of an inspection object item in a process of inspecting the semiconductor device and determining a numerical determination value for an inspection object item of an inspection object image by using an interpolation method of adding the products of representative values of the respective categories and probabilities of belonging to the respective categories.

One or more embodiments of the present invention include a method of inspecting a semiconductor device, in which since multi-channel images are directly used as a verification dataset for deep learning and an input image for inspection, the multi-channel images including an in-focus image of an object, an out-of-focus image whose distance from a lens to an image plane is shorter than an actual focal distance, and an out-of-focus image whose distance from a lens to an image plane is longer than the actual focal distance, TSOM images need not be formed and thus a registration process is unnecessary, thereby reducing an image acquisition time.

According to one or more embodiments, a method of acquiring a TSOM includes: acquiring a plurality of actual images of different focal positions and out-of-focus degrees (distances) of the actual images with respect to an inspection object through an optical tool; acquiring a plurality of virtual images having different focal positions from the actual images and the focal positions thereof, based on the actual images and the out-of-focus degrees of the actual images; and acquiring a TSOM image of the inspection object by using the actual images and the virtual images.

The acquiring of the plurality of virtual images and the focal positions thereof may include: acquiring the plurality of actual images of different focal positions; and acquiring the plurality of virtual images having different focal positions from the actual images and the focal positions thereof by using interpolation based on information (data) related to the focal positions and the actual images.

The focal positions of the virtual images acquired by using the interpolation may be assumed to form a Gaussian distribution with respect to an in-focus distance, and when the focal positions of the virtual images are selected, a weighted arrangement method may be adopted so that focal positions close to an in-focus position are arranged to be dense and out-of-focus positions are arranged to be sparse.

That is, an out-of-focus image may be acquired by weighting the focal positions adjacent to a focal length. As a result, since a weighted TSOM image is acquired, a TSOM image having higher reliability may be acquired.

The actual images may be composed of three images including an in-focus image of the inspection object, an out-of-focus image whose distance from a lens to an image plane is shorter than an actual focal distance, and an out-of-focus image whose distance from a lens to an image plane is longer than the actual focal distance.

In the process of acquiring the plurality of virtual images and the focal positions thereof, an analysis of a given optical system and a transformation formula (transformation program) representing the analysis may be used. In order to acquire the plurality of virtual images having different focal positions from the actual images and the focal positions thereof based on a smaller number of actual images and an out-of-focus degree of each actual image, an optical system may be analyzed by using a Fourier modal method (FMM), a plurality of virtual images having the same focal positions as the actual images may be acquired by using setting (characteristics) of the optical system obtained through the analysis of the optical system and compared with the actual images, a more suitable analysis of the optical system and a transformation formula (transformation program) for the suitable analysis may be acquired based on the comparison, and the plurality of virtual images having different focal positions from the actual images and the focal positions of the plurality of virtual images may be acquired through the transformation formula.

In the process of acquiring the plurality of virtual images and the focal positions thereof, the interpolation and the transformation formula may be used together. It may be difficult to sufficiently analyze the optical system through two or three actual images. Thus, in aspects of the present invention, primarily, a virtual image for some focal positions different from the focal position of the actual image may be acquired by a relatively simple optical system analysis and transformation formula.

A light source that illuminates the inspection object so as to acquire the actual images may use a surface light source having a single wavelength for analyzing the optical system through the FMM. Also, monochromatic light or a light source having a single wavelength may be used.

According to one or more embodiments, a method of inspecting a semiconductor device includes: a process of acquiring images of a plurality of semiconductor device parts, whose at least one inspection object item (parameter) and category (class) within the item are known, and storing the inspection object item, the category, and the images in a storage list (database) in association with one another as a verification dataset for deep learning; a determining process of preparing a basic tool of a default state for inspection in a combined form of computer hardware and software, classifying a category to which each image belongs by performing deep learning on the at least one inspection object item based on the images of the storage list, comparing the classification result with a classification result obtained by the storage list, performing deep learning until the classification result satisfies a prescribed criterion, and determining a tool of a state having software suitable in a state satisfying the criterion as an inspection tool suitable for inspection; and an inspecting process of acquiring an inspecting object image of an unknown semiconductor device part and finding an inspection object item of the inspection object image and a category to which the inspection object image belongs by using the inspection tool determined through the deep learning.

In the inspecting process, the category of the inspection object item to which the inspection object image belongs is represented by not a simple yes/no determination method but a probability distribution method for all categories of the inspection object item.

The category may be represented by a numerical range.

A numerical decision value for the inspection object item of the inspection object image may be determined by adding the products of representative values of the respective categories and probabilities of belonging to the respective categories.

The category of the inspection object item to which the inspection object image belongs may be represented by not a simple yes/no determination method but a probability distribution method for all categories of the inspection object item, and the probability for each category may be used to determine a specific value among the categories of the items of the object having the image through the interpolation or the weighted average method.

For example, when each category is composed of a numerical range, the value determination for the inspection object item of the inspection object image may be performed by adding the products of representative values of the respective categories and probabilities of belonging to the respective categories with respect to all categories. In this case, the representative value may be a median or a mode commonly used in statistics.

In addition, the value determination may be performed by a method of removing values having a probability equal to or less than a specific threshold value among probability values of categories (classes) (outlier removal), securing only categories showing meaningful probabilities, obtaining the products thereof by using each representative value and a probability value, and adding the products, and a (nonlinear interpolation) method of deriving a multi-dimensional equation by using the probability values of the categories and applying the derived multi-dimensional equation to the interpolation, not a (linear interpolation) method of simply multiplying the representative values by the probabilities to be included in the representative categories and adding the results.

The images of the plurality of semiconductor device parts, whose at least one inspection object item (parameter) and category (class) within the item are known, and the inspection object image of the unknown semiconductor device part may be through-focus scanning optical microscopy (TSOM) images.

The TSOM images of the plurality of semiconductor device parts, whose at least one inspection object item (parameter) and category (class) within the item are known, and the inspection object TSOM image of the unknown semiconductor device part may be acquired by a method of acquiring a TSOM image, the method including: acquiring a plurality of actual images of different focal positions and out-of-focus degrees (distances) of the actual images with respect to the plurality of semiconductor device parts or the unknown semiconductor device part through an optical tool; acquiring a plurality of virtual images having different focal positions from the actual images and focal positions thereof, based on the actual images and the out-of-focus degrees of the actual images; and acquiring the TSOM images of the plurality of semiconductor device parts, whose at least one inspection object item (parameter) and category (class) within the item are known, and the inspection object TSOM image of the unknown semiconductor device part by using the actual images and the virtual images.

The acquiring of the plurality of virtual images and the focal positions thereof may include: acquiring the plurality of actual images of different focal position; and acquiring the plurality of virtual images having different focal positions from the actual images and the focal positions thereof by using interpolation based on information (data) related to the focal positions and the actual images.

The focal positions of the virtual images acquired by using the interpolation may be assumed to form a Gaussian distribution with respect to an in-focus distance.

When the focal positions of the virtual images are selected, a weighted arrangement method may be adopted so that focal positions close to an in-focus position are arranged to be dense and out-of-focus positions are arranged to be sparse.

The actual images may be composed of three images including an in-focus image of an inspection object with respect to the plurality of semiconductor device parts or the unknown semiconductor device part, an out-of-focus image whose distance from a lens to an image plane is shorter than an actual focal distance, and an out-of-focus image whose distance from a lens to an image plane is longer than the actual focal distance.

In order to reduce time and cost for acquisition of the TSOM images in the process of acquiring TSOM images of a plurality of semiconductor patterns, whose shapes and sizes are known, and arranging the TSOM images and the pattern shapes and sizes as database data by storing them in association with each other, actual photos having different focal depths, which are obtained through an optical tool, may be three or more per pattern, more images having different focal depths may be artificially acquired through interpolation, and TSOM images may be acquired through more photos.

In order to acquire the plurality of virtual images and the focal positions of the plurality of virtual images, an optical system may be analyzed by using a Fourier modal method (FMM), the plurality of virtual images having the same focal positions as the actual images are acquired by using setting (characteristics) of the optical system obtained through the analysis of the optical system and are compared with the actual images, a more suitable analysis of the optical system and a transformation formula (transformation program) for the suitable analysis are acquired based on the comparison, and the plurality of virtual images having different focal positions from the actual images and the focal positions of the plurality of virtual images may be acquired through the transformation formula.

A light source that illuminates the inspection object so as to acquire the actual images may use a surface light source having a single wavelength for analyzing the optical system through the FMM.

The images of the plurality of semiconductor device parts, whose at least one inspection object item (parameter) and category (class) within the item are known, and the image of the unknown semiconductor device part may be multi-channel images including an in-focus image of an inspection object with respect to the plurality of semiconductor device parts or the unknown semiconductor device part, whose at least one inspection object item (parameter) and category (class) within the item are known, M out-of-focus images whose distance from a lens to an image plane is shorter than an actual focal distance, and N out-of-focus images whose distance from a lens to an image plane is longer than the actual focal distance, and the M and the N may be any integer from 1 to 4.

The M and the N may be identical to each other, and the M and the N may be 1.

Since the tool is suitable for the inspection object item through deep learning, preparation may be made to confirm the item and category to which an individual image belongs by classifying data of the storage list into items and categories, so as to confirm whether the result classified by the tool is accurate in a middle stage where the tool of the deep learning is not determined.

However, since preparing images for all items and categories and sufficient images for each category is very difficult in an initial stage, the images may be prepared through simulation. In this case, a simulation program may be prepared so that at least a part of the images prepared through the simulation are confirmed through actual measurement and great deviation does not occur, and the simulation may be performed by reflecting general interpolation.

When deep learning is performed on at least one inspection object item, features of a plurality of images of the verification dataset may be searched for through an algorithm (software or program) included in the basic tool, the plurality of images of the verification dataset may be classified by the features thereof, the classification result may be compared with a classification result obtained by a storage list, when the comparison result satisfies a certain criterion, the tool of a current state may be determined as the inspection tool, when the comparison result does not satisfy the certain criterion, a process of searching for a new feature while modifying the basic tool through an algorithm modification may be repeated until the comparison result satisfies the certain criterion or may be repeated until a certain number of times is satisfied, and a tool of a current time after the repetition may be determined as the inspection tool.

One individual tool may be formed for one parameter and a set of individual tools may be formed for all items (parameters) necessary for inspection.

When inspection tools for the plurality of inspection object items are determined in the determining process, an individual tool may be determined by applying deep learning to the basic tool with respect to one of the plurality of items, and a plurality of individual tools may be determined with respect to the plurality of items, and in the inspecting process, the plurality of individual tools may be applied to the inspection object images to find to which category the inspection object images belong for each of the plurality of items.

The inspection object item may include one of an upper width, a lower width, a depth, a height, and an inclined angle of each of a hole, a through silicon via (TSV), a groove, and a line pattern protruding from a plane in a semiconductor device, and the category may have an allowable numerical range to which the inspection object item belongs. In the case of the hole or the TSV, the inspection object item or the parameter may be an inlet diameter, a bottom diameter, and a depth of the hole or the via.

When the shape and size of the unknown semiconductor device part are determined by the method according to aspects of the present invention, the determined shape and size may be compared with a normal pattern to determine the presence or absence of a defect on the pattern. A wafer or a die having the detected defect may be reprocessed or discarded. The inspection object item itself may be the presence or absence of abnormality, and the category may be a decision value of abnormality or normality.

According to aspects of the present invention, when the item, the category, and the image of the semiconductor device part (inspection object) are stored in the storage list (database), the database may maintain an open state so as to enable continuous security.

For example, when the unknown semiconductor device part is determined as a defect by the method according to aspects of the present invention, a detailed item and category of the defect may be determined by applying another inspection such as SEM thereto, the result may be added to the storage list, the tool (including the database) may be compensated by performing deep learning again by using the storage list, and the inspection result may be obtained by inspecting a new unknown semiconductor device part through the tool.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart showing main operations of a method of inspecting a semiconductor device, according to an embodiment of the present invention;

FIG. 2 is a flowchart of a method of acquiring a TSOM image, according to an embodiment of the present invention;

FIG. 3 is a conceptual diagram for describing a concept of a method of obtaining image data of different focal positions for an inspection object or a verification dataset through optical analysis using FMM and acquiring a TS OM image through the obtained image data;

FIGS. 4 to 6 are tables showing category classification of TSOM images of a plurality of line patterns as data for deep learning with respect to three items, that is, a line width, a height, and a line width/height;

FIG. 7 is a conceptual configuration diagram illustrating an example of a model that determines an inspection tool through deep learning;

FIGS. 8 and 9 are diagrams showing an example of results obtained in the form of a probability distribution of belonging to each numerical category of line width and height items when data of a new test set is input to an inspection tool determined through deep learning using a verification dataset, according to an embodiment of the present invention;

FIG. 10 is a flowchart of a method of inspecting a semiconductor device, according to another embodiment of the present invention; and

FIG. 11 is a conceptual diagram illustrating a method of inspecting a semiconductor device, according to an embodiment of the present invention.

### DETAILED DESCRIPTION

### Description of the Preferred Embodiments

Hereinafter, the present invention will be described in more detail with reference to inspecting methods according to embodiments of the present invention.

Hereinafter, embodiments of the present invention will be described in detail with reference to the accompanying drawings.

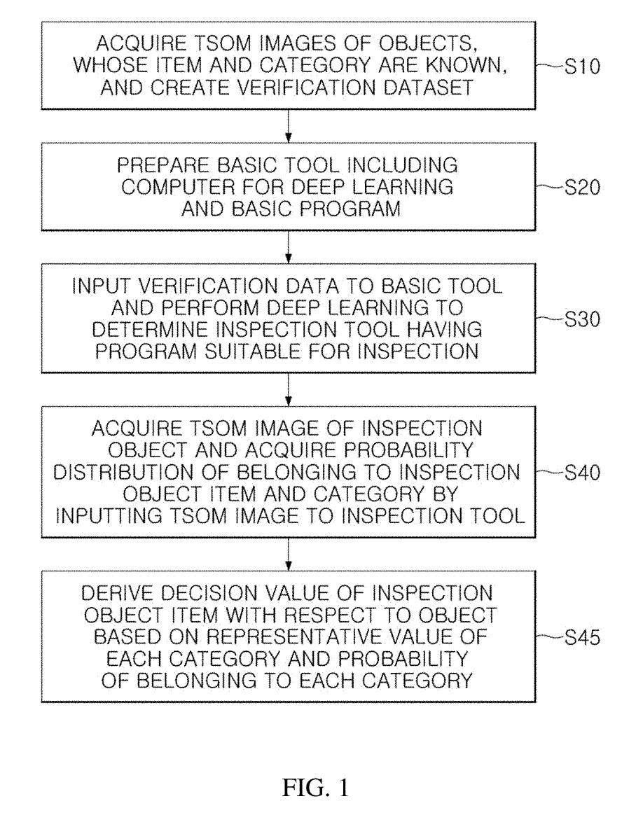

FIG. 1 is a flowchart showing main operations of a method of inspecting a semiconductor device, according to an embodiment of the present invention.

According to this embodiment, in operation S10, TSOM images are acquired for a plurality of semiconductor device parts, for example, lines having various upper widths, heights, and inclined angles.

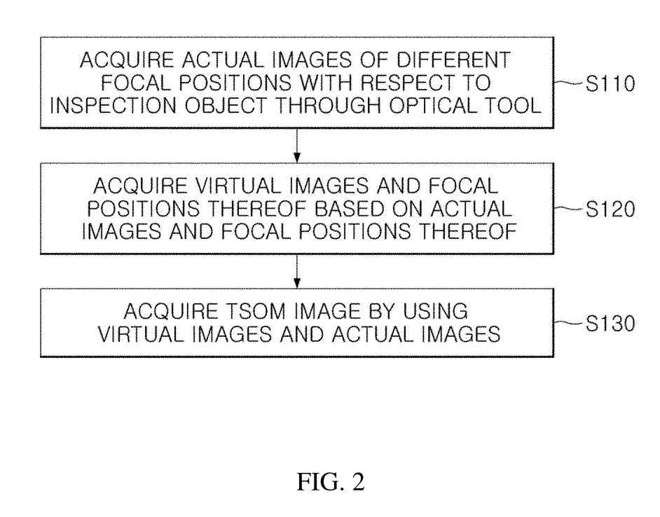

In this case, since a lot of TSOM images of an object are required, a distinctive method of acquiring a TSOM image according to aspects of the present invention as shown in a flowchart of FIG. 2 may be used.

That is, in operation S110, an optical system for a TSOM of each inspection object acquires images at different focal positions, acquires actual images of an object at less focal positions, for example, three or five focal positions, unlike a conventional TSOM image acquiring method of combining and processing images in terms of light intensity or chromatic aberration, and acquires these image and focal position information of each image.

Then, in operation S120, a plurality of virtual images having different focal positions from the actual images and focal positions thereof are acquired based on these actual images and out-of-focus degrees thereof. Finally, in operation S130, a TSOM image of an object is acquired by using the actual images and the virtual images through a process of combining and processing images in terms of light intensity or chromatic aberration as in the related art.

In this regard, in operation S120 of acquiring the plurality of virtual images and the focal positions thereof, when the actual images of different focal positions and the focal positions of the actual images are acquired, a process of acquiring a plurality of virtual images having different focal positions from the actual images and focal positions thereof may be performed by using interpolation based on these data.

The interpolation is a method of reasonably inferring a magnitude of a system of coordinates between these based on a boundary condition or a magnitude of a system on a plurality of known coordinates. Since the interpolation is well known in the fields of mathematics, science, and engineering, a detailed description thereof will be omitted, and a simple average method or a weighted average method may be used according to situations.

On the other hand, in operation of acquiring the plurality of virtual images and the focal positions thereof, an analysis of a given optical system and a transformation formula (transformation program) well representing the analysis may be used.

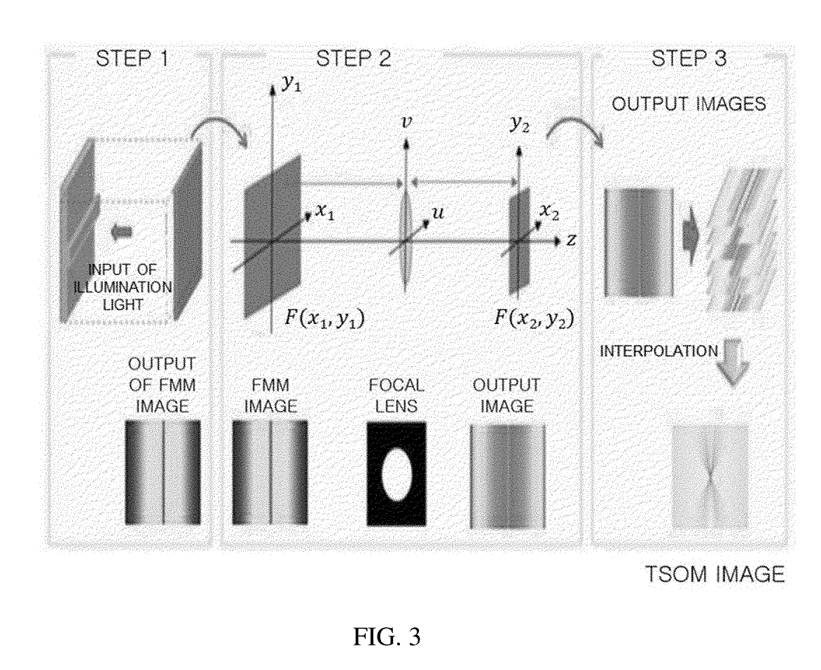

For example, as illustrated in FIG. 3, a method of analyzing an optical system including an illumination, an inspection object, and an image plane by using a Fourier modal method (FMM) may be used in step 1. In this case, light of a surface light source having an uniform wavelength may be regarded as an input, and an FMM image detected on the image plane after illuminating a surface of an object and experiencing a reflection action may be regarded as an output.

Once the FMM image is acquired, the FMM image is used again as an input, and an output image can be acquired on an image plane located at a distance d2 from a lens through an operation of an optical element, that is, a lens located at a distance d1 from the image plane. In this case, while changing d2, an output image can be acquired at a position that matches, is short of, or is beyond a focal length of the lens.

When the optical analysis of the optical system acquiring the FMM image and the lens serving as the optical element is accurately performed and the corresponding transformation formula is obtained, it is possible to calculate a lens for an inspection object and a shape to be obtained on an image plane at a certain distance and determine whether an optical analysis or a transformation formula is valid by comparing the actual image with the captured and calculated image.

For example, an optical system is analyzed by using an FMM, and a plurality of virtual images having the same focal positions as actual images are acquired by using setting (characteristics) of the optical system obtained through the analysis of the optical system. Based on this, the analysis of the optical system is modified to obtain an appropriate analysis and an acceptable transformation formula. Then, a plurality of virtual images having different focal positions from the actual images are acquired through the acceptable transformation formula. In one embodiment of the present invention, the optical system is analyzed by using the FMM, but the present invention is not limited thereto. The optical system may be analyzed by using other types of simulators.

In operation of acquiring the plurality of virtual images and the focal positions thereof, the interpolation and the transformation formula may be used together. In reality, it is difficult to sufficiently analyze the actual optical system having a plurality of optical elements through two or three actual images, so as to clearly represent the features thereof. Primarily, a virtual image for some focal positions different from the focal position of the actual image is acquired by a relatively simple optical system analysis and transformation formula.

On the other hand, in specific application of the interpolation, the focal positions of the virtual image are assumed to form a Gaussian distribution with respect to an in-focus distance. When the focal position of the virtual image is selected, a weighted arrangement method may be adopted so that focal positions close to the in-focus position are arranged to be dense, and focal positions greatly deviated from the focus are arranged to be sparse. That is, an out-of-focus image may be acquired by weighting the focal positions adjacent to the focal length. As a result, since weighted TSOM images are acquired, TSOM images having higher reliability can be acquired.

In the case of using the interpolation, the focal positions of the virtual images obtained through the interpolation are assumed to form a Gaussian distribution with respect to an in-focus distance. When the focal position of the virtual image is selected, a weighted arrangement method may be adopted so that focal positions close to the in-focus position are arranged to be dense, and focal positions greatly deviated from the focus are arranged to be sparse. That is, an out-of-focus image may be acquired by weighting the focal positions adjacent to the focal length. As a result, since weighted TSOM images are acquired, TSOM images having higher reliability can be acquired.

Then, in operation S10, the TSOM images are prepared as a verification dataset for deep learning. As one of preparations, each TSOM image, an inspection object item thereof, a category to which the item belongs among size categories thereof are stored in the form of a database.

In order to advantageously form a tool through deep learning even with a relatively small number when forming the verification dataset, the TSOM images may be uniformly distributed with respect to each inspection object and a numerical range (category) where each inspection object is located, in a state in which each inspection object (parameter) and a size thereof, such as heights, upper widths, and inclined angles of the TSOM image and target lines thereof, are known.

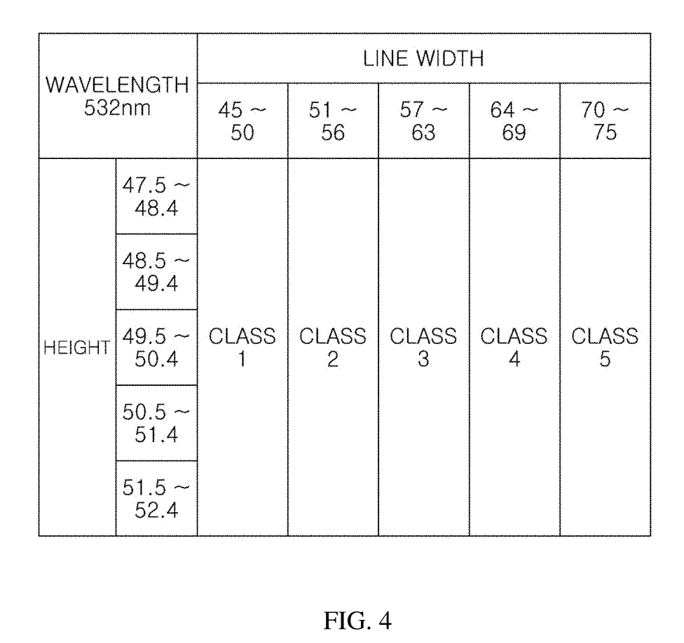

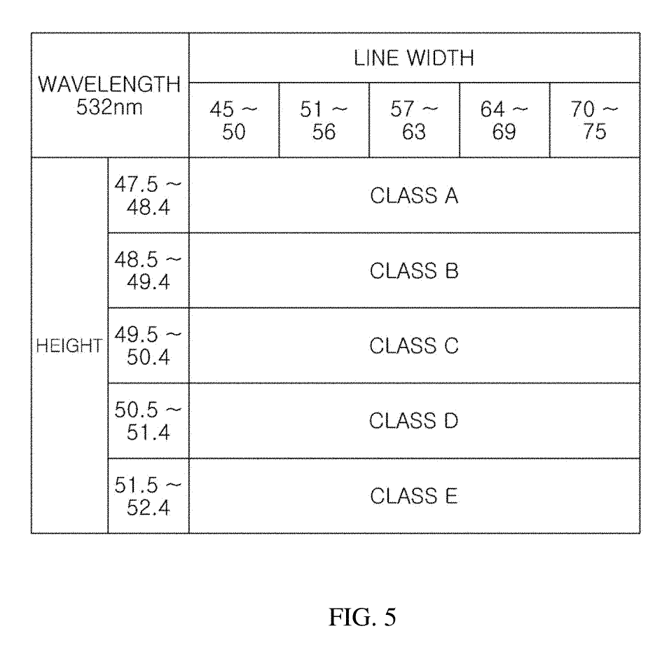

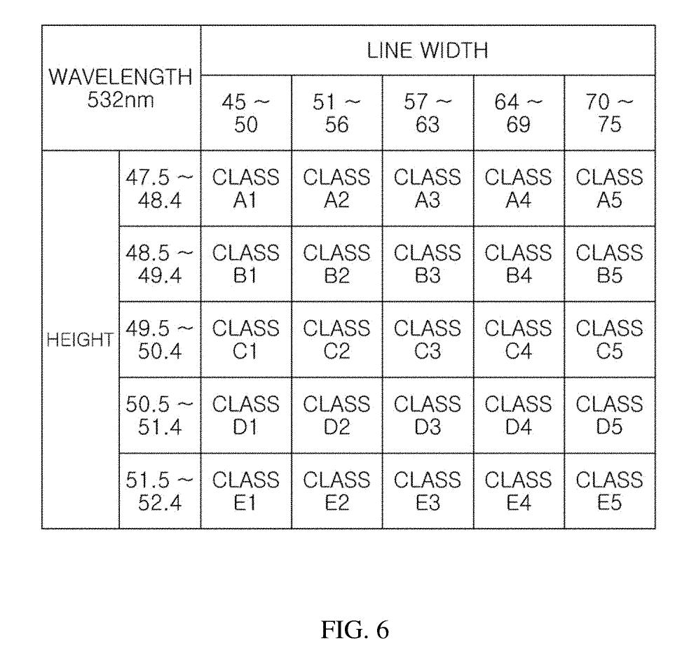

For example, the verification dataset is prepared so as to form an algorithm suitable for inspection through deep learning in a semiconductor device inspection tool or form a program in a specific form, and the verification dataset forms a distribution of FIG. 4 in terms of the line width of the line pattern and a distribution of FIG. 5 in terms of the height of the line pattern. The TSOM images constituting the verification dataset may be divided into classes 1 to 5 according to the numerical range of the upper width as shown in FIG. 4. The TSOM images may be divided into classes A to E according to the numerical range of the height as shown in FIG. 5. Also, the entire TSOM images may be divided into 25 sub-classes according to the numerical range in terms of the upper width and the height as shown in FIG. 6. When each sub-class has 100 TSOM images, a total of 2,500 TSOM images are provided. The respective TSOM images are identified by unique numbers.

It is preferable that the line patterns are produced to have objects such as various line widths, heights, or inclined angles, and a numerical category for each object, the object and the category are checked through an actual inspection of the line patterns, and the TSOM images thereof are secured to thereby prepare the verification dataset. However, it is difficult to actually manufacture various reticles and form semiconductor device patterns having various items and categories by using expensive semiconductor equipment. Therefore, a practical method may be to secure TSOM images by using several existing semiconductor device patterns, whose items and categories are already known, and prepare the verification dataset by combining the TSOM images having a numerical category therebetween by using a simulation.

Also, the storage list (database) as data for deep learning is managed in an open type so as to increase inspection suitability. Thus, TSOM images having inspection object items and categories continue to be additionally compensated. When an increase in the number of data of the storage list is greater than or equal to a certain value, operation of determining the inspection tool through deep learning may be newly performed to determine a new inspection tool.

It is known that combining a plurality of TSOM images of different numerical categories through the simulation is somewhat possible through the current TSOM technology. Conversely, if the actual TSOM image is found by actually manufacturing the object corresponding to the item and category of the combined TSOM image or finding the corresponding pattern among existing semiconductor device patterns, the TSOM image can be combined to have no great difference from the actual TSOM image, even though it is a limited category.

Then, a basic tool is prepared in operation S20, and TSOM images of the primary database material is input to the basic tool as deep learning materials. The tool is composed of a combination of a computer and a program executed in the computer. The program can be used while changing detailed setting of a program that is substantially the same as an existing developed shape recognition program. The program has a neural network structure design capable of recognizing features of an object item through a TSOM image and an algorithm enabling neural network learning. As the learning is progressed, a basic algorithm setting is changed to make a concretely suitable algorithm. For example, as the learning is progressed, weighting and function activation may be performed on learnt nodes. Since the concepts related to deep learning are already known, a detailed description thereof will be omitted.

In aspects of the present invention, the inspection tool classifies input data by comparing features in terms of inspection object items. In a deep learning process, features or specific patterns of a plurality of TSOM images are found through the algorithm (software or program) included in the basic tool, the TSOM images are classified by the features thereof, and it is checked whether the TSOM images are matched with the classification by the item and category whose results are known (database data created in the previous operation). If not matched, an activity to classify TSOM images again through features or specific patterns is continued while modifying the tool through own algorithm, and an inspection tool by deep learning may be regarded as being determined when a predetermined criterion is satisfied, for example, when the matching is more than a certain probability in operation S30.

When the program of the inspection tool is made to be appropriate and concrete through deep learning, it is preferable to simplify the inspection object items and reduce the number of categories so as to perform deep learning easily and efficiently in a short time. For example, the tool is divided into five categories with respect to only the line width of the line as shown in the table of FIG. 4, and a line width inspection tool is determined. Then, the tool is divided into five categories with respect to only the height of the line as shown in the table of FIG. 5, and a height inspection tool is determined. It may be considered that the entire inspection tools are obtained through the combination of the inspection tools for the respective items.

In the case of determining and selecting the inspection tool for each inspection object item, for example, in the case of intending to find TSOM images belonging to a specific line width category and a specific height category among TSOM images with respect to the line, TSOM images belonging to the specific line width category are found, TSOM images belonging to the specific line height category are found, and then, TSOM images belonging to the intersection thereof are found.

In this case, it is possible to reduce time necessary for deep learning and increase suitability. Also, when the inspection object item is randomly expanded, the tool may be easily compensated through deep learning with respect to added object items. On the contrary, when the classification is performed based on two or more inspection items through deep learning at a time, a total of 25 object categories are provided. Thus, the time necessary for deep learning is rapidly increased. When the time is limited, the tool is determined with low accuracy.

When the inspection tool is determined through these processes, it is possible to confirm the accuracy and reliability of the inspection tool through an additional verification dataset or test set.

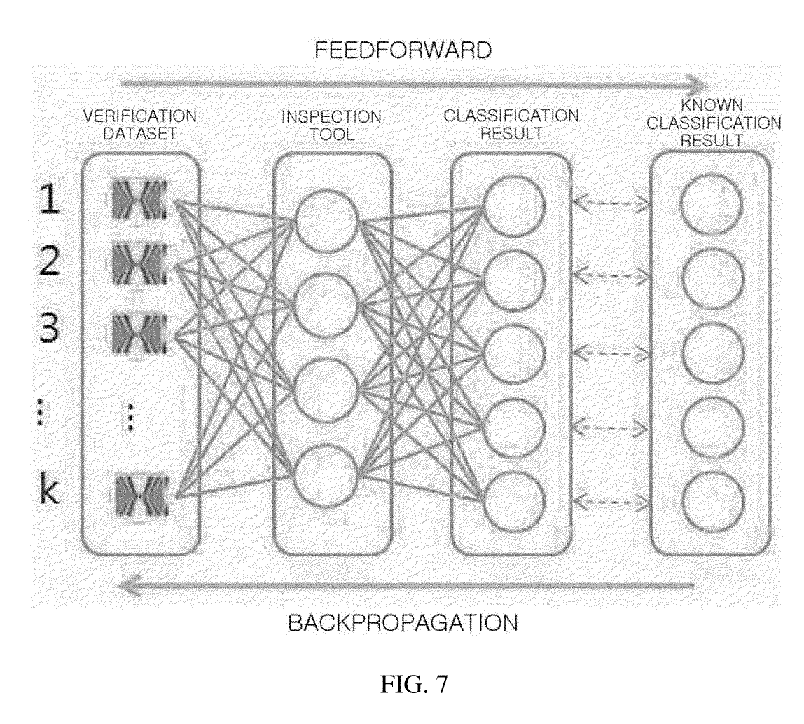

FIG. 7 is a conceptual configuration diagram illustrating an example of a model that determines an inspection tool through deep learning. In this model, an input dataset is represented by output data through a hidden layer corresponding to an inspection tool (feedforward direction). When the input dataset is all TSOM images constituting a verification dataset, to which category each TSOM image constituting the TSOM image set belongs is represented by output data. The inspection tool is determined when the output data matches both the inspection item and the category associated with the TSOM image according to the already secured database. If not matched, the current inspection tool modifies its own algorithm or program again (backpropagation). Then, the above-described classification is performed through the modified algorithm, and these processes may be repeated.

Whenever the modification is performed once, it may be considered that one epoch has passed. In the iteration process, when an error rate is equal to or lower than a reference error rate (a rate calculated by dividing the number of misclassified data by the total number of data), or when the epoch reaches an epoch number arbitrarily designated by a designer, it may be also considered that the inspection tool is determined.

When the inspection tool for the line width and the inspection tool for line height are determined through the above processes, the line width and the height of the inspection object line, whose numerical range is unknown, are inspected based on the determined inspection tools. As the input data of the inspection tool, a TSOM image of an unknown line is prepared and an inspection result is obtained by inputting the prepared TSOM image to the inspection tool in operation S40. The TSOM image of the unknown line is acquired based on the TSOM image acquiring method illustrated in FIG. 2.

The inspection output of the object is represented by which numerical range (category) of the line width the object line belongs to and which numerical range of the height the object line belongs to. If these numerical ranges are criterion for determining a defect of an object, a process of discarding or reprocessing the semiconductor device that has an object line and is in a manufacturing process may be performed in subsequent operations according to the criterion.

On the other hand, the output of the inspection is not a format of determining whether or not the inspection object simply belongs to a specific category of an object item, but may be represented by a distribution format of probability of a belonging to a plurality of categories, for example, what percent is a probability of belonging to a certain category.

The reason why the output of the inspection has the probability distribution format is that the object item does not clearly show an actual shape and a size in a TSOM image but is represented by a slight abstract pattern.

Generally, regarding such a probability distribution, a representative value of a category having the highest distribution probability may be determined as a result value for an inspection item of an inspection object. However, the representative value is usually a median value, and the accuracy of the inspection result is lowered if the numerical range increases.

In order to compensate such a disadvantage so that the inspection result has a more accurate value, the inspection result having a distribution probability with respect to each numerical category may be used. That is, as described above, the object item does not clearly show an actual shape and size in the TSOM image, but is represented by a slightly abstract pattern. Thus, paradoxically, the format of the probability distribution containing such unclearness may be used to determine a more accurate value of the inspection object item. That is, it can be assumed that the inspection object belongs to the numerical range of the object item and also has a certain specific number within the numerical range.

To this end, in operation S45, a decision value of the inspection object item may be derived with respect to the object based on the representative value of each category and the probability of belonging to the category. In this deriving process, an interpolation or a weighted average may be applied.

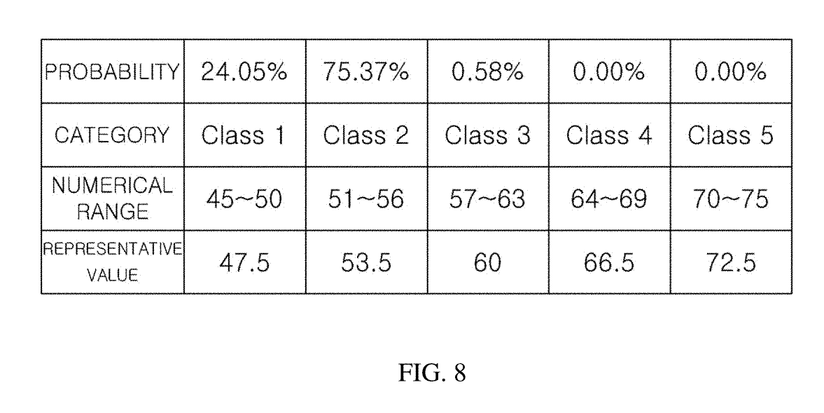

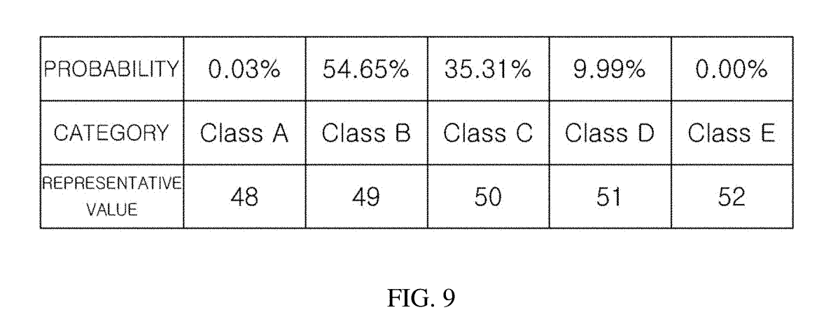

FIGS. 8 and 9 are diagrams showing results for a line width and a height, which are obtained in the form of a probability distribution of belonging to each numerical category of each item when data of a test set is input to a tool determined through deep learning using a verification dataset. As test data, a TSOM image of a line having a line width of 51 nm, a height of 50 nm, and a lower inclined angle of 89 degrees was obtained and then input to a tool determined in relation to the line width to obtain the following results that a probability of belonging to class 1 corresponding to a representative value of 47.5 in a numerical range of 45 nm to 50 nm was 24.05%, a probability of belonging to class 2 corresponding to a representative value of 53.5 in a numerical range of 51 nm to 56 nm was 75.37%, a probability of belonging to class 3 corresponding to a representative value of 60 in a numerical range of 57 nm to 63 nm was 0.58%, a probability of belonging to class 4 corresponding to a representative value of 66.5 in a numerical range of 64 nm to 69 nm was 0%, and a probability of belonging to class 5 corresponding to a representative value of 72.5 in a numerical range of 70 nm to 75 nm was 0%.

Also, the TSOM was input to a tool determined in relation to the height item to the following results that a probability of belonging to class A corresponding to a representative value of 48 nm was 0.03%, a probability of belonging to class B corresponding to a representative value of 49 nm was 54.65%, a probability of belonging to class C corresponding to a representative value of 50 nm was 35.31%, a probability of belonging to class D corresponding to a representative value of 51 nm was 9.99%, and a probability of belonging to class E corresponding to a representative value of 52 nm was 0%.

From these results, it is usual that the line width is 53.5, which is the representative value of class 2, and the height is 49 nm, which is the representative value of class B. However, in aspects of the present invention, the products of representative values of the respective categories and the probabilities of belonging to the respective categories are all added to obtain the results that the line width is 52.095 nm and the height is 49.5525 nm as a weighted average value or a value calculated by an interpolation. These values are much closer to the line width of 51 nm and the height of 50 nm that are the known measured values of the line pattern. That is, values much closer to the measured values can be obtained through the interpolation.

When the inspection result obtained by the interpolation was measured in unit of nm, a measurement error and a standard deviation in the case according to the conventional MSD method were respectively 3.1197 and 2.3937, but a measurement error and a standard deviation in the case according to the present invention were respectively reduced to 3.093 and 2.0552. When comparing the time taken for measurement, as the number of TSOM images constituting the database increased, the time taken for calculation in the conventional MSD method proportionally increased. The time was measured to be 783.2 ms for 155 pieces of data of the database, 5032.2 ms for 1,000 pieces of data of the database, 10065.7 ms for 2,000 pieces of data of the database, and 25161.3 ms for 5,000 pieces of data of the database. However, according to aspects of the present invention, the time was 21.1 ms for 155 pieces of data. When the number of data increased, an absolute value increased but did not proportionally increase. Thus, it was seen that, even when the number of data increased, very little time was taken to obtain the inspection result value of the measurement object.

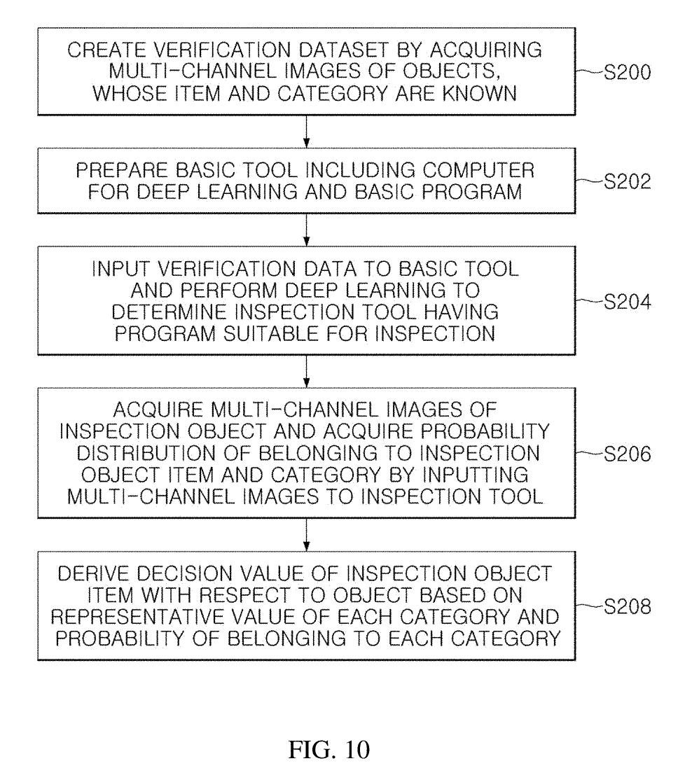

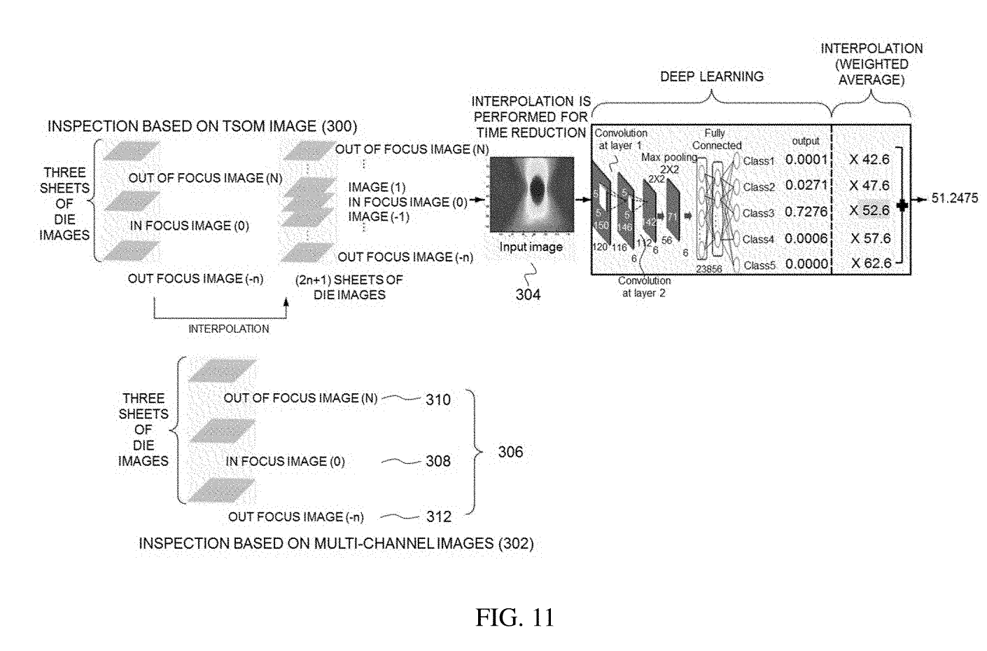

FIG. 10 is a flowchart showing main operations of a method of inspecting a semiconductor device, according to another embodiment of the present invention, and FIG. 11 is a conceptual diagram of a method of inspecting a semiconductor device, according to an embodiment of the present invention.

Referring to FIG. 10, the method of inspecting the semiconductor device, according to another embodiment of the present invention, includes: operation S200 of acquiring multi-channel images of a plurality of semiconductor device parts, whose at least one inspection object item (parameter) and a category (class) within the item are known, and storing the inspection object item, the category, and the images in a storage list (database) in a state of being associated with one another as a verification dataset for deep learning; operation S202 of preparing a basic tool of a default state for inspection in a combined form of computer hardware and software; determining operation S204 of classifying a category of each image by performing deep learning on at least one inspection object item based on the images of the storage list, comparing the classification result with a classification result obtained by the storage list, performing deep learning until the classification result satisfies a prescribed criterion, and determining a tool of a state having software suitable in a state satisfied with a regulation, as an inspection tool suitable for inspection; and inspecting operations S206 and S208 of acquiring multi-channel images of an inspection object with respect to unknown semiconductor device parts and finding an inspection object item and a category of an inspection object image by using the inspection tool determined through the deep learning.

In the inspecting operation, the category of the inspection object item to which the inspection object image belongs is represented by not a simple yes/no determination method but a probability distribution method for all categories of the inspection object item, and the categories are represented by numerical ranges (operation S206). A numerical decision value for the inspection object item of the inspection object image is determined by adding the products of representative values of the respective categories and probabilities of belonging to the respective categories (operation S208).

The method of inspecting the semiconductor device as shown in FIG. 10, according to another embodiment of the present invention, is similar to the method of inspecting the semiconductor device as shown in FIG. 1, according to one embodiment of the present invention.

In the method (300 of FIG. 11) of inspecting the semiconductor device as shown in FIG. 1, according to one embodiment of the present invention, three sheets of actual images for an object are acquired, virtual images are formed based on the actual images, a TSOM image 304 is formed based on the actual images and the virtual images, and the semiconductor device is inspected by using the TSOM image as a verification dataset for deep learning and an input image for inspection.

However, in the method (302 of FIG. 11) of inspecting the semiconductor device as shown in FIG. 10, according to another embodiment of the present invention, a TSOM image is not formed and the semiconductor device is inspected by directly using multi-channel images 306 as a verification dataset for deep learning and an input image for inspection, wherein the multi-channel images 306 include an in-focus image 308, an out-of-focus image 310 whose distance from a lens to an image plane is shorter than an actual focal distance, and an out-of-focus image 312 whose distance from a lens to an image plane is longer than the actual focal distance.

In the case of a Through Silicon Via (TSV) formed in a semiconductor device, a size of a hole is different according to a depth due to structural characteristics and more noise components are present than a FinFET structure due to the influence of illumination. Due to the influence of noise and different sizes of hole images, it is difficult to accurately register the in-focus image and the plurality of out-of-focus images so as to form the TSOM image. Therefore, a problem may occur in inspection accuracy according to image registration.

In order to solve this problem, in the method (302 of FIG. 11) of inspecting the semiconductor device as shown in FIG. 10, according to another embodiment of the present invention, a TSOM image is not formed and the semiconductor device is inspected by directly using the multi-channel images 306 as the verification dataset for deep learning and an input image for inspection. Since the image registration process for forming the TSOM image is unnecessary, the inspection accuracy may be improved and the image acquisition time may be reduced.

In the method (302 of FIG. 11) of inspecting the semiconductor device as shown in FIG. 10, according to another embodiment of the present invention, a total of three multi-channel images 306 are used, wherein the three multi-channel images 306 include the in-focus image 308, the out-of-focus image 310 whose distance from a lens to an image plane is shorter than the actual focal distance, and the out-of-focus image 312 whose distance from a lens to an image plane is longer than the actual focal distance. However, one embodiment of the present invention is not limited thereto. A total of (M+N+1) multi-channel images may be used, wherein the (M+N+1) multi-channel images include an in-focus image, M out-of-focus image whose distance from a lens to an image plane is shorter than the actual focal distance, and M out-of-focus images whose distance from a lens to an image plane is longer than the actual focal distance.

M and N may be any integer from 1 to 4, and M and N may be identical to or different from each other.

In the method of acquiring the TSOM image according to one or more embodiments of the present invention, it is possible to acquire high-precision TSOM images of the object with less effort and time, as compared to the related art, and to inspect the semiconductor device efficiently at low costs.

In the method of acquiring the TSOM image according to one or more embodiments of the present invention, it is possible to acquire an image having a sufficient number of different focal depths to obtain an accurate TSOM image while not greatly or frequently changing optical setting or positions of the object in a direction of a focal distance. When the deep learning and the TSOM image are applied to the method of inspecting the semiconductor device, a plurality of TSOM image knowing the inspection object item of the inspection object and the category for each item can be easily secured with less time and effort and low costs in order to construct the database that may matter most, thereby achieving practical inspection.

According to one or more embodiments of the present invention, since limitations of the conventional method of inspecting the semiconductor device by TSOM, such as the use of MSD, can be overcome, it is possible to provide the method of inspecting the semiconductor device, which can be used for inspecting the semiconductor device more practically and more efficiently in terms of inspection time and accuracy.

According to one or more embodiments of the present invention, it is possible to inspect the semiconductor device efficiently and at low costs while providing advantages of TSOM by combining a deep learning concept with the inspection of the semiconductor device using a TSOM technology.

Also, in the method of inspecting the semiconductor device according to one or more embodiments of the present invention, it is possible to minimize an inspection error by representing an inspection object image in a probability distribution form with respect to all categories of an inspection object item in a process of inspecting the semiconductor device and determining a numerical determination value for an inspection object item of an inspection object image by using an interpolation method of adding the products of representative values of the respective categories and probabilities of belonging to the respective categories.

Also, in the method of inspecting the semiconductor device according to one or more embodiments of the present invention, since multi-channel images are directly used as a verification dataset for deep learning and an input image for inspection, the multi-channel images including an in-focus image of an object, an out-of-focus image whose distance from a lens to an image plane is shorter than an actual focal distance, and an out-of-focus image whose distance from a lens to an image plane is longer than the actual focal distance, TSOM images need not be formed and thus a registration process is unnecessary, thereby reducing an image acquisition time.

Although preferred embodiments of the present invention have been described for illustrative purposes, those skilled in the art will appreciate that various modifications, additions and substitutions are possible, without departing from the scope and spirit of the invention as disclosed in the accompanying claims. Therefore, the embodiments of the present invention are disclosed only for illustrative purposes and should not be construed as limiting the present invention.

### DESCRIPTION OF REFERENCE NUMERALS

304: TSOM image

306: Multi-channel image

308: In-focus image

310, 312: Out-of-focus image.

What is claimed is:

1. A method of acquiring a through-focus scanning optical microscopy (TSOM) image, the method comprising:
acquiring a plurality of actual images of different focal positions and out-of-focus degrees (distances) of the actual images with respect to an inspection object through an optical tool;
acquiring a plurality of virtual images having different focal positions from the actual images and the focal positions thereof, based on the actual images and the out-of-focus degrees of the actual images; and
acquiring a TSOM image of the inspection object by using the actual images and the virtual images.

2. The method of claim 1, wherein the acquiring of the plurality of virtual images and the focal positions thereof comprises:
acquiring the plurality of actual images of different focal positions; and
acquiring the plurality of virtual images having different focal positions from the actual images and the focal positions thereof by using interpolation based on information (data) related to the focal positions and the actual images.

3. The method of claim 2, wherein the focal positions of the virtual images acquired by using the interpolation are assumed to form a Gaussian distribution with respect to an in-focus distance, and
when the focal positions of the virtual images are selected, a weighted arrangement method is adopted so that focal positions close to an in-focus position are arranged to be dense and out-of-focus positions are arranged to be sparse.

4. The method of claim 1, wherein the actual images are composed of three images including an in-focus image of the inspection object, an out-of-focus image whose distance from a lens to an image plane is shorter than an actual focal distance, and an out-of-focus image whose distance from a lens to an image plane is longer than the actual focal distance.

5. The method of claim 1, wherein, in order to acquire the plurality of virtual images and the focal positions of the plurality of virtual images,
an optical system is analyzed by using a Fourier modal method (FMM),
the plurality of virtual images having the same focal positions as the actual images are acquired by using setting (characteristics) of the optical system obtained through the analysis of the optical system and are compared with the actual images,
a more suitable analysis of the optical system and a transformation formula (transformation program) for the suitable analysis are acquired based on the comparison, and
the plurality of virtual images having different focal positions from the actual images and the focal positions of the plurality of virtual images are acquired through the transformation formula.

6. The method of claim 5, wherein a light source that illuminates the inspection object so as to acquire the actual images uses a surface light source having a single wavelength for analyzing the optical system through the FMM.

7. A method of inspecting a semiconductor device, the method comprising:
a process of acquiring images of a plurality of semiconductor device parts, whose at least one inspection object item (parameter) and category (class) within the item are known, and storing the inspection object item, the category, and the images in a storage list (database) in association with one another as a verification dataset for deep learning;
a determining process of preparing a basic tool of a default state for inspection in a combined form of computer hardware and software, classifying a category to which each image belongs by performing deep learning on the at least one inspection object item based on the images of the storage list, comparing the classification result with a classification result obtained by the storage list, performing deep learning until the classification result satisfies a prescribed criterion, and determining a tool of a state having software suitable in a state satisfying the criterion as an inspection tool suitable for inspection; and
an inspecting process of acquiring an inspecting object image of an unknown semiconductor device part and finding an inspection object item of the inspection object image and a category to which the inspection object image belongs by using the inspection tool determined through the deep learning.

8. The method of claim 7, wherein, in the inspecting process, the category of the inspection object item to which the inspection object image belongs is represented by not a simple yes/no determination method but a probability distribution method for all categories of the inspection object item,
the category is represented by a numerical range, and
a numerical decision value for the inspection object item of the inspection object image is determined by adding the products of representative values of the respective categories and probabilities of belonging to the respective categories.

9. The method of claim 7, wherein the images of the plurality of semiconductor device parts, whose at least one inspection object item (parameter) and category (class) within the item are known, and the inspection object image of the unknown semiconductor device part are through-focus scanning optical microscopy (TSOM) images, and
the TSOM images of the plurality of semiconductor device parts, whose at least one inspection object item (parameter) and category (class) within the item are known, and the inspection object TSOM image of the unknown semiconductor device part are acquired by a method of acquiring a TSOM image, the method including:
acquiring a plurality of actual images of different focal positions and out-of-focus degrees (distances) of the actual images with respect to the plurality of semiconductor device parts or the unknown semiconductor device part through an optical tool;
acquiring a plurality of virtual images having different focal positions from the actual images and focal positions thereof, based on the actual images and the out-of-focus degrees of the actual images; and
acquiring the TSOM images of the plurality of semiconductor device parts, whose at least one inspection object item (parameter) and category (class) within the item are known, and the inspection object TSOM image of the unknown semiconductor device part by using the actual images and the virtual images.

10. The method of claim 9, wherein the acquiring of the plurality of virtual images and the focal positions thereof comprises:
acquiring the plurality of actual images of different focal position; and
acquiring the plurality of virtual images having different focal positions from the actual images and the focal positions thereof by using interpolation based on information (data) related to the focal positions and the actual images.

11. The method of claim 10, wherein the focal positions of the virtual images acquired by using the interpolation are assumed to form a Gaussian distribution with respect to an in-focus distance, and
when the focal positions of the virtual images are selected, a weighted arrangement method is adopted so that focal positions close to an in-focus position are arranged to be dense and out-of-focus positions are arranged to be sparse.

12. The method of claim 9, wherein the actual images are composed of three images including an in-focus image of an inspection object with respect to the plurality of semiconductor device parts or the unknown semiconductor device part, an out-of-focus image whose distance from a lens to an image plane is shorter than an actual focal distance, and an out-of-focus image whose distance from a lens to an image plane is longer than the actual focal distance.

13. The method of claim 9, wherein, in order to acquire the plurality of virtual images and the focal positions of the plurality of virtual images,
an optical system is analyzed by using a Fourier modal method (FMM),
the plurality of virtual images having the same focal positions as the actual images are acquired by using setting (characteristics) of the optical system obtained through the analysis of the optical system and are compared with the actual images,
a more suitable analysis of the optical system and a transformation formula (transformation program) for the suitable analysis are acquired based on the comparison, and
the plurality of virtual images having different focal positions from the actual images and the focal positions of the plurality of virtual images are acquired through the transformation formula.

14. The method of claim 13, wherein a light source that illuminates the inspection object so as to acquire the actual images uses a surface light source having a single wavelength for analyzing the optical system through the FMM.

15. The method of claim 7, wherein the images of the plurality of semiconductor device parts, whose at least one inspection object item (parameter) and category (class) within the item are known, and the image of the unknown semiconductor device part are multi-channel images including an in-focus image of an inspection object with respect to the plurality of semiconductor device parts or the unknown semiconductor device part, whose at least one inspection object item (parameter) and category (class) within the item are known, M out-of-focus images whose distance from a lens to an image plane is shorter than an actual focal distance, and N out-of-focus images whose distance from a lens to an image plane is longer than the actual focal distance, and
the M and the N are any integer from 1 to 4.

16. The method of claim 15, the M and the N are identical to each other.

17. The method of claim 16, wherein the M and the N are 1.

18. The method of claim 7, wherein, when deep learning is performed on at least one inspection object item, features of a plurality of images of the verification dataset are searched for through an algorithm (software or program) included in the basic tool,
the plurality of images of the verification dataset are classified by the features thereof,
the classification result is compared with a classification result obtained by a storage list,
when the comparison result satisfies a certain criterion, the tool of a current state is determined as the inspection tool,
when the comparison result does not satisfy the certain criterion, a process of searching for a new feature while modifying the basic tool through an algorithm modification is repeated until the comparison result satisfies the certain criterion or is repeated until a certain number of times is satisfied, and
a tool of a current time after the repetition is determined as the inspection tool.

19. The method of claim 7, wherein, when inspection tools for the plurality of inspection object items are determined in the determining process,
an individual tool is determined by applying deep learning to the basic tool with respect to one of the plurality of items, and a plurality of individual tools are determined with respect to the plurality of items, and
in the inspecting process, the plurality of individual tools are applied to the inspection object images to find to which category the inspection object images belong for each of the plurality of items.

20. The method of claim 7, wherein the inspection object item includes one of an upper width, a lower width, a depth, a height, and an inclined angle of each of a hole, a through silicon via (TSV), a groove, and a line pattern protruding from a plane in a semiconductor device, and
the category has an allowable numerical range to which the inspection object item belongs.
